(19) United States
(12) Patent Application Publication
(10) Pub. No.: US 2026/0247231 A1
(43) Pub. Date: Aug. 20, 2026

(54) L1/L2 TRIGGERED MOBILITY RECOVERY

(71) Applicant: InterDigital Patent Holdings, Inc., Wilmington (DE)

(72) Inventors: Martino FREDA, Laval (CA); Oumer TEYEB, Montreal (CA); Brian MARTIN, Farnham (GB); Paul MARINIER, Brossard (CA); Dylan WATTS, Montreal (CA); Keiichi KUBOTA, Setagaya-Ku, Tokyo (JP); Erdem BALA, East Meadow, NY (US)

(73) Assignee: InterDigital Patent Holdings, Inc., Wilmington (DE)

(21) Appl. No.: 19/472,032

(22) PCT Filed: Apr. 4, 2024
(86) PCT No.: PCT/US2024/023028

§ 371 Date: Oct. 2, 2025

Related U.S. Application Data
(60) Provisional application No. 63/494,132, filed on Apr. 4, 2023.

(51) Int. Cl. H04W 36/00; H04W 74/0833; H04W 76/19

(52) U.S. Cl. CPC H04W 36/0079; H04W 74/0833; H04W 76/19

(57) ABSTRACT

A wireless transmit/receive unit (WTRU) may receive information indicating a set of L1/L2 mobility (LTM) candidate cells, information indicating a threshold number of cells, information indicating a threshold cell quality value, and information indicating cells served by a same distributed unit (DU) as a current cell. The WTRU may determine that a radio link failure (RLF) or handover failure occurs on the current cell. If a number of LTM candidate cells measured above the threshold cell quality value is above the threshold number of cells and at least one of the LTM candidate cells which is above the threshold cell quality value is served by the same DU as the current cell, the WTRU may select one of the LTM candidate cells above that threshold cell quality value that is served by the same DU. The WTRU may perform LTM recovery to the selected LTM candidate cell.

### CROSS-REFERENCE TO RELATED APPLICATIONS

This application claims the benefit of U.S. Provisional Application No. 63/494,132, filed Apr. 4, 2023, the contents of which are incorporated herein by reference.

### BACKGROUND

In a RRC_CONNECTED mode, a wireless transmit/receive unit (WTRU) measures multiple beams (e.g. at least one beam) of a cell and the measurement results (e.g. power values) are averaged to derive a cell quality. In doing so, the WTRU is configured to consider a subset of the detected beams. Filtering takes place at two different levels: at the physical layer to derive a beam quality and then at the radio resource control (RRC) level to derive a cell quality from multiple beams. Cell quality from beam measurements is derived in the same way for the serving cell(s) and for the non-serving cell(s). Measurement reports may comprise the measurement results of the X best beams if the WTRU is configured to do so by the gNB.

### SUMMARY

A wireless transmit/receive unit (WTRU) may be configured for L1/L2 mobility (LTM) recovery. The WTRU may be configured to receive information indicating a set of LTM candidate cells. The WTRU may be configured to receive information indicating a threshold number of cells. The WTRU may be configured to receive information indicating a threshold cell quality value. The WTRU may be configured to receive information indicating cells served by a same distributed unit (DU) as a current cell. The WTRU may be configured to determine that a radio link failure (RLF) or handover (HO) failure occurs on the current cell. On a condition that a number of LTM candidate cells measured above the threshold cell quality value is above the threshold number of cells and at least one of the LTM candidate cells which is above the threshold cell quality value is served by the same DU as the current cell, the WTRU may be configured to select one of the LTM candidate cells above that threshold cell quality value that is served by the same DU. The WTRU may be configured to perform LTM recovery to the selected LTM candidate cell. Performing LTM recovery may comprise transmitting a random access channel (RACH) transmission. On a condition that a number of LTM candidate cells measured above the threshold cell quality value is not above the threshold number of cells or at least one of the LTM candidate cells which is above the threshold cell quality value is not served by the same DU as the current cell, the WTRU may be configured to: select a cell that is not an LTM candidate cell, release an LTM configuration; and perform conditional handover (CHO) or reestablishment. Performing CHO may comprise transmitting a radio resource control (RRC) reconfiguration complete message. Performing reestablishment may comprise transmitting a radio resource control (RRC) reestablishment request message to the selected cell that is not an LTM candidate cell. The threshold cell quality value may be a reference signal received power (RSRP) value. The WTRU may be configured to measure a cell quality of the LTM candidate cells against the threshold cell quality value. The WTRU may be configured to determine whether a number of LTM candidate cells measured above the threshold cell quality value is above the threshold number of cells. The WTRU may be configured to determine whether at least one of the LTM candidate cells which is above the threshold cell quality value is served by the same DU as the current cell. The selecting one of the LTM candidate cells may be based on a cell quality, a cell grouping, a WTRU speed, a change in WTRU location, a change in WTRU height, a type of failure, a network indication, or a timing alignment.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example high-level measurement model;

FIG. 3 shows an example of L1/2 triggered mobility (LTM) using carrier aggregation (CA);

FIG. 4 shows an example LTM baseline procedure;

FIG. 5 shows an example reestablishment recovery procedure;

FIG. 6 show an example method of LTM recovery based on a number of suitable LTM candidates at the time of RLF and/or a DU relationship with a current cell;

FIG. 7 shows an example method for releasing or maintaining an LTM configuration following an RLF based on a number of suitable LTM candidates at the time of RLF, a WTRU speed, and/or a DU relationship of the remaining candidates; and

FIG. 8 shows an example method of LTM recovery based on presence of an acceptable LTM cell and a presence, amount, or type of ongoing uplink data transmission.

### DETAILED DESCRIPTION

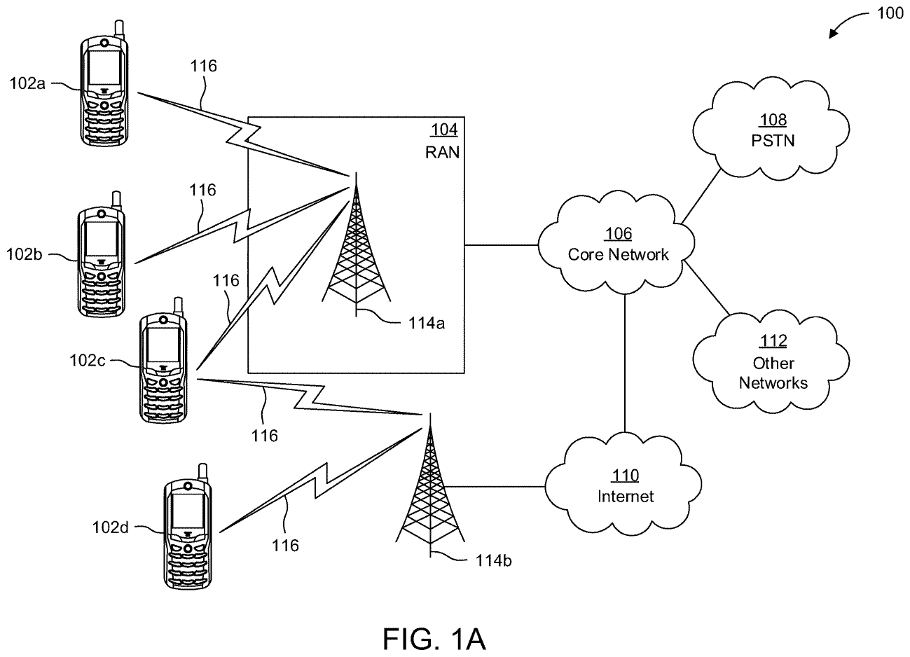

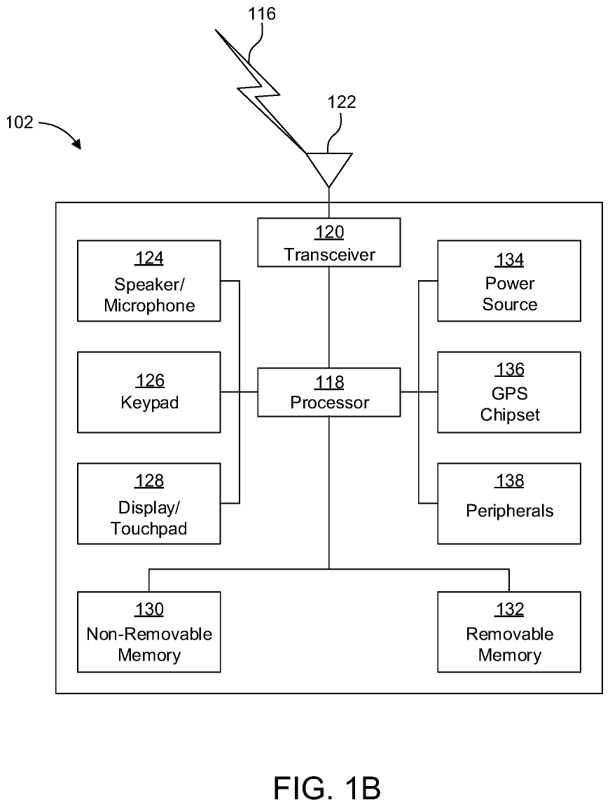

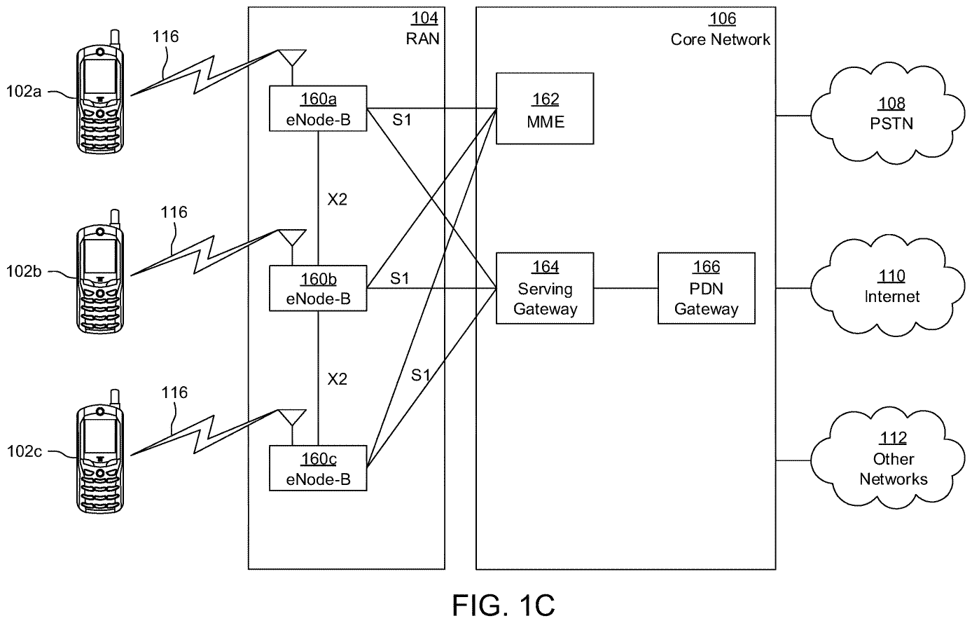

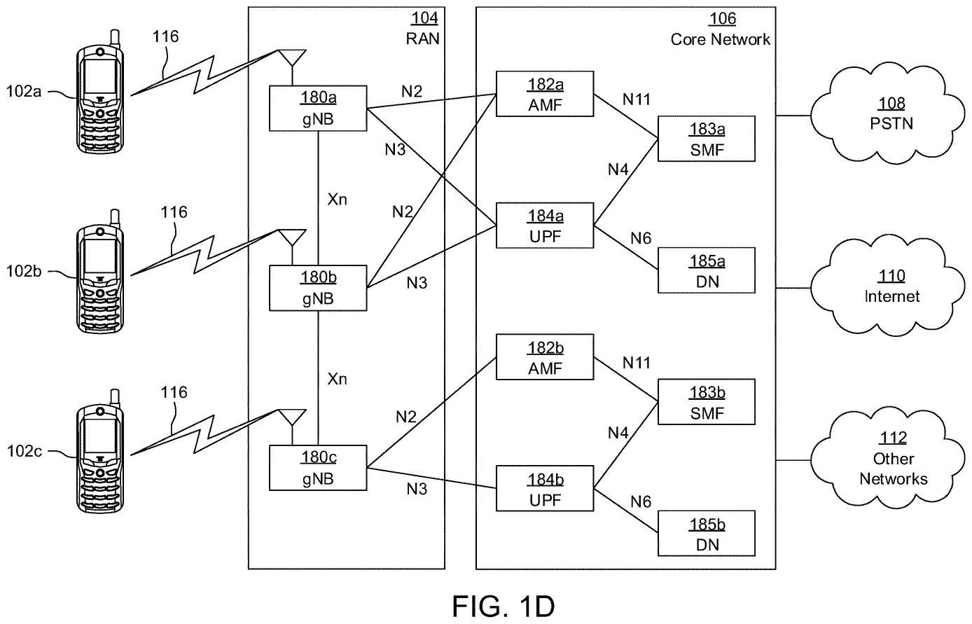

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VOIP) services to one or more of the WTRUS 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The term special cell (SpCell) may either refer to the primary cell (PCell) of the master cell group (MCG) or the primary secondary cell group (SCG) (PSCell) of the secondary cell group (SCG) depending on whether the medium access control (MAC) entity is associated to the MCG or the SCG.

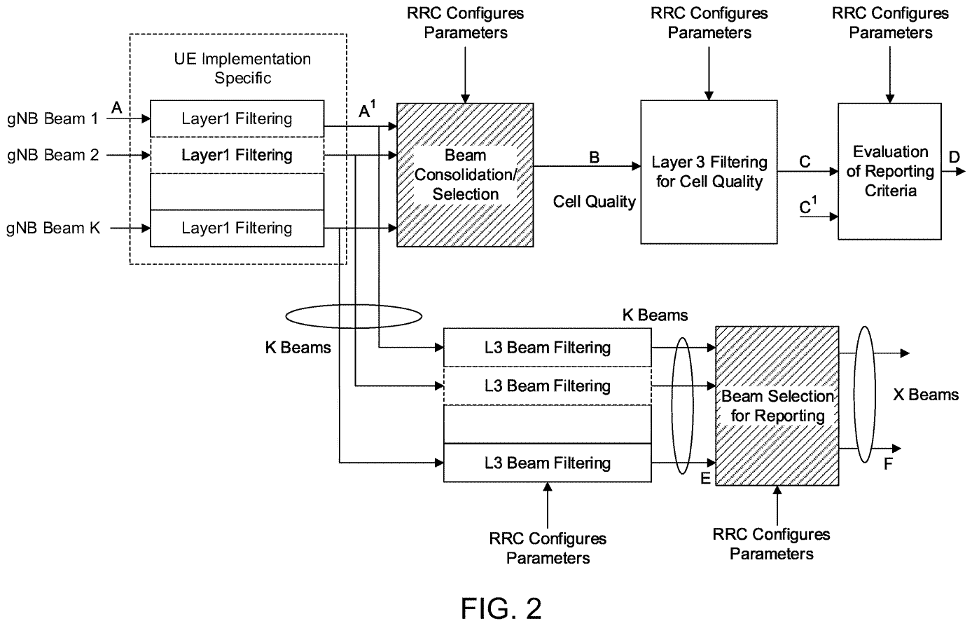

An example of a high-level measurement model is shown in FIG. 2. K beams correspond to the measurements on a synchronization signal block (SSB) or channel state information-reference signal (CSI-RS) resources configured for L3 mobility by a gNB and detected by a WTRU at L1. ‘A’ refers to measurements (i.e. beam specific samples) internal to the physical layer. Layer 1 filtering refers to internal layer 1 filtering of the inputs measured at point A. Exact filtering is implementation dependent. How the measurements are actually executed in the physical layer by an implementation (inputs A and Layer 1 filtering) is not constrained by the standard. A¹ refers to measurements (i.e. beam specific measurements) reported by layer 1 to layer 3 after layer 1 filtering. Beam Consolidation/Selection refers to beam specific measurements are consolidated to derive a cell quality. The behavior of the Beam consolidation/selection is standardized and the configuration of this module is provided by RRC signaling. Reporting period at B equals one measurement period at A¹. ‘B’ refers to a measurement (i.e. cell quality) derived from beam-specific measurements reported to layer 3 after beam consolidation/selection. Layer 3 filtering for cell quality refers to filtering performed on the measurements provided at point B. The behavior of the Layer 3 filters is standardized and the configuration of the layer 3 filters is provided by RRC signaling. Filtering reporting period at C equals one measurement period at B. ‘C’ refers to a measurement after processing in the layer 3 filter. The reporting rate is identical to the reporting rate at point B. This measurement is used as input for one or more evaluation of reporting criteria. Evaluation of reporting criteria refers to checks whether actual measurement reporting is necessary at point D. The evaluation may be based on more than one flow of measurements at reference point C (e.g. to compare between different measurements). This is illustrated by input C and C¹. The WTRU shall evaluate the reporting criteria at least every time a new measurement result is reported at point C, C¹. The reporting criteria are standardized and the configuration is provided by RRC signaling (WTRU measurements). ‘D’ refers to measurement report information (e.g. message) sent on the radio interface. L3 Beam filtering refers to filtering performed on the measurements (i.e. beam specific measurements) provided at point A¹. The behavior of the beam filters is standardized and the configuration of the beam filters is provided by RRC signaling. Filtering reporting period at E equals one measurement period at A¹. ‘E’ refers to a measurement (i.e. beam-specific measurement) after processing in the beam filter. The reporting rate is identical to the reporting rate at point A¹. This measurement is used as input for selecting the X measurements to be reported. Beam Selection for beam reporting refers to selecting the X measurements from the measurements provided at point E. The behavior of the beam selection is standardized and the configuration of this module is provided by RRC signaling. ‘F’ refers to beam measurement information included in measurement report (i.e. sent) on the radio interface.

Layer 1 filtering introduces a certain level of measurement averaging. How and when a WTRU exactly performs the required measurements is implementation specific to the point that the output at B fulfils performance requirements, for example, as in 3GPP TS 38.133. Layer 3 filtering for cell quality and related parameters used are specified for example, in 3GPP TS 38.331 and do not introduce any delay in the sample availability between B and C. C¹ is the input used in the event evaluation. L3 Beam filtering and related parameters used are specified in 3GPP TS 38.331 and do not introduce any delay in the sample availability between E and F.

Currently in 3GPP R17 inter-cell beam management can be used which can manage the beams in a carrier aggregation (CA) case, but no cell change/add is supported.

In 3GPP R18 one of the objectives of the work item (WI) “Further NR Mobility Enhancements” in RP-213565 is to specify mechanisms and procedures of L1/L2 based inter-cell mobility for mobility latency reduction. To specify mechanisms and procedures of L1/L2 based inter-cell mobility for mobility latency reduction: Configuration and maintenance for multiple candidate cells to allow fast application of configurations for candidate cells [RAN2, RAN3]; Dynamic switch mechanism among candidate serving cells (including SpCell and SCell) for the potential applicable scenarios based on L1/L2 signaling [RAN2, RAN1]; L1 enhancements for inter-cell beam management, including L1 measurement and reporting, and beam indication [RAN1, RAN2]; Note 1: Early RAN2 involvement is necessary, including the possibility of further clarifying the interaction between this bullet with the previous bullet; Timing Advance management [RAN1, RAN2]; CU-DU interface signaling to support L1/L2 mobility, if needed [RAN3]. Note 2: FR2 specific enhancements are not precluded, if any. Note 3: The procedure of L1/L2 based inter-cell mobility are applicable to the following scenarios: Standalone, CA and NR-DC case with serving cell change within one CG; Intra-DU case and intra-CU inter-DU case (applicable for Standalone and CA: no new RAN interfaces are expected); Both intra-frequency and inter-frequency; Both FR1 and FR2; Source and target cells may be synchronized or non-synchronized; Inter-CU case is not included.

L1/L2 based mobility was originally started in 3GPP R17 and inter-cell beam management in R17 addresses intra-distributed unit (DU) and intra-frequency scenarios. In this case the serving cell remains unchanged (i.e. there is no possibility to change the serving cell using L1/2 based mobility). In FR2 deployments, CA is typically used in order to exploit the available bandwidth (e.g. to aggregate multiple component carriers (CCs) in one band). These CCs are typically transmitted with the same analog beam pair (gNB beam and WTRU beam). The WTRU is configured with transmission configuration indicator (TCI) states, and may have fairly large number (e.g. 64) for reception of a physical downlink control channel (PDCCH) and physical downlink shared channel (PDSCH). Each TCI state includes a reference signal (RS) or SSB that the WTRU refers to for setting its beam. The SSB may be associated with a non-serving physical cell identity (PCI). MAC signaling (“TCI state indication for WTRU-specific PDCCH MAC CE”) activates the TCI state for a Coreset/PDCCH. Reception of a PDCCH from a non-serving cell is supported by a MAC control element (CE) indicating a TCI state associated to a non-serving PCI. MAC signaling (“TCI States Activation/Deactivation for WTRU-specific PDSCH”) activates a subset of up to 8 TCI states for PDSCH reception. A downlink control information (DCI) indicates which of the 8 TCI states. A “unified TCI state” is supported with a different updating mechanism (DCI-based), but without multi-transmission/reception point (TRP). A unified TCI state with multi-TRP is supported.

An objective of L1/L2 triggered mobility (LTM) is to improve handover latency, with a conventional L3 handover or conditional the WTRU will typically first send a measurement report using RRC signaling. In response to this, the network may provide a further measurement configuration and potentially a conditional handover configuration. With a conventional handover, the network provides a configuration for a target cell after the WTRU reports using RRC signaling that the cell meets a configured radio quality criteria. With conditional handover (CHO), in order to reduce the handover failure rate due to the delay in sending a measurement report then receiving an RRC reconfiguration, the network provides, in advance, a target cell configuration as well as a measurement criteria which determines when the WTRU should trigger the CHO configuration. Both of these L3 methods, however, suffer from some amount of delay due to the sending of measurement reports and receiving of target configurations, particularly in case of the conventional (non-conditional) handover.

A goal of LTM is to allow a fast application of configurations for candidate cells, including dynamically switching between SCells and switching of the PCell (e.g. switch the roles between SCell and PCell) without performing RRC signaling. The inter-centralized unit (CU) case is not included, as this requires relocation of the packet data convergence protocol (PDCP) anchor. Therefore, an RRC based approach is needed at least to support inter-CU handover.

Furthermore, with the legacy L3 handover procedures, any currently active SCell(s) are released before the WTRU moves and completes the handover to a target cell in the coverage area of a new site, and may only be added back after successful handover, which leads to throughput degradation during handover. A goal of L1/2 is therefore to enable CA operation to be enabled instantaneously upon serving cell change.

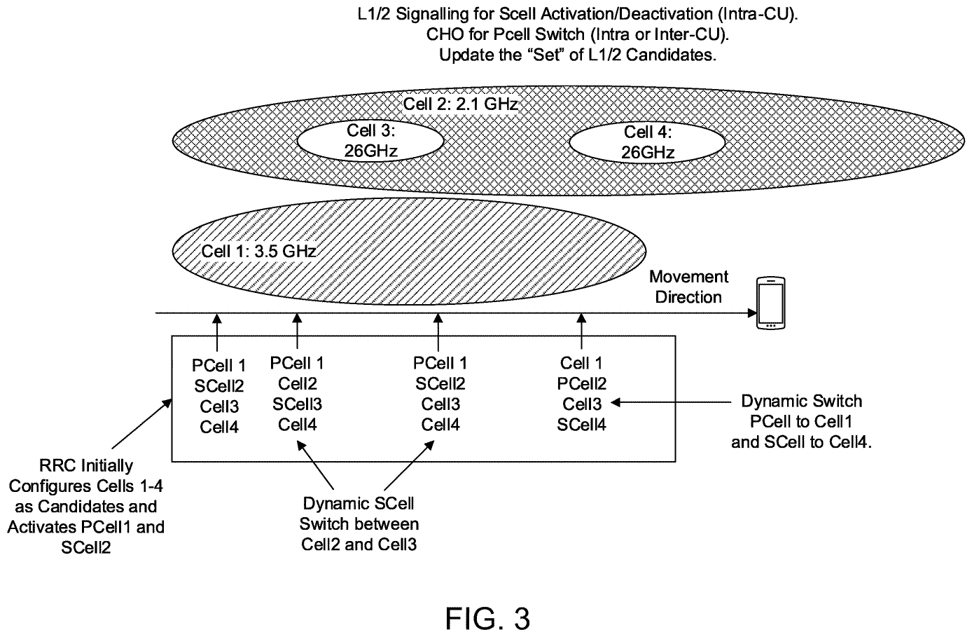

FIG. 3 shows an example of LTM operation, whereby a candidate cell group is configured by RRC and a dynamic switch of PCell and SCell is achieved using L1/2 signaling.

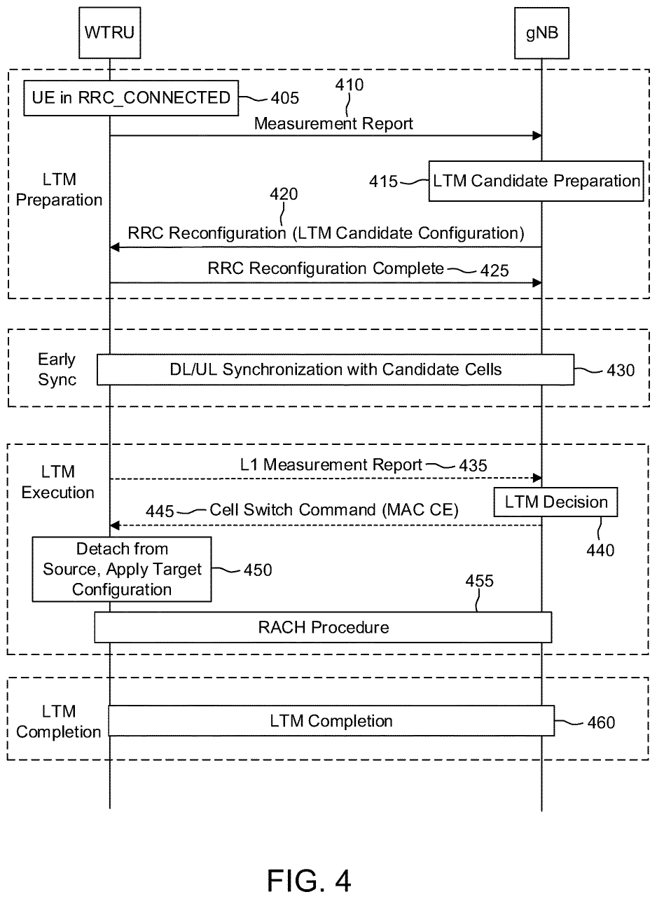

A baseline procedure for LTM is shown in FIG. 4. A WTRU may be in an RRC_Connected mode or state 405. The WTRU may send a MeasurementReport message to a gNB 410. The gNB may decides to use LTM and initiate LTM candidate preparation 415. The gNB may transmit an RRC Reconfiguration message to the WTRU including the configuration of one or multiple LTM candidate target cells 420. The WTRU may store the configuration of LTM candidate target cell(s) and transmit a RRC Reconfiguration Complete message to the gNB 425. The WTRU may perform DL synchronization and TA acquisition with candidate target cell(s) before receiving a LTM cell switch command 430. DL synchronization for candidate cell(s) before cell switch command is supported, at least based on SSB. TA acquisition of candidate cell(s) before LTM cell switch command is supported, at least based on PDCCH ordered random access channel (RACH), where the PDCCH order is only triggered by source cell. The WTRU may perform L1 measurements on the configured LTM candidate target cell(s), and transmit lower-layer measurement reports to the gNB 435. The gNB may decide to execute LTM cell switch to a target cell 440. The gNB may transmit information indicating a cell switch (e.g. cell switch command) in, for example, a MAC CE that triggers LTM cell switch by including the candidate configuration index of the target cell 445. The WTRU may switch to the configuration of the LTM candidate target cell 450. The WTRU may detach from the source and apply target configurations. The WTRU may perform a random access (RACH) procedure towards the target cell, if TA is not available 455. The WTRU may indicate successful completion of the LTM cell switch towards the target cell 460. An uplink signal or message after the WTRU has switched to the target cell may be used to indicate successful completion of the LTM cell switch.

Recovery procedures are defined that may be initiated in the case of a failure while in RRC_CONNECTED. Specifically, following a Uu radio link failure (RLF), handover (HO) failure, or reconfiguration failure the WTRU may trigger a recovery procedure to try to re-establish the RRC connection without having to transition to RRC IDLE. This allows the WTRU context to be maintained.

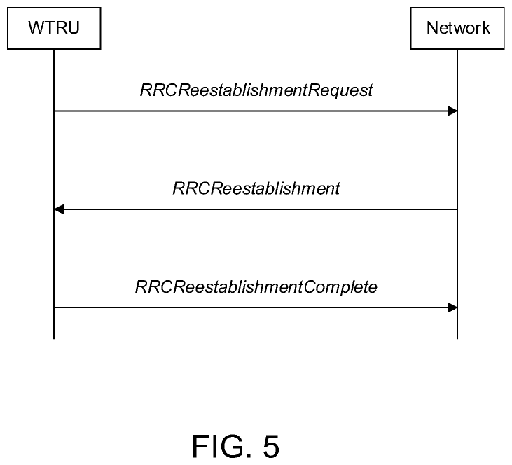

A basic procedure associated with recovery is re-establishment where the WTRU first performs cell selection and selects a suitable cell (e.g. RSRP above a threshold and the WTRU is allowed to connect to the cell) and initiates a re-establishment procedure which comprises of transmitting an RRC Reestablishment Request (e.g. RRCReestablishmentRequest) message. An example reestablishment procedure is shown in FIG. 5.

An enhanced recovery procedure was introduced during the introduction of conditional handover (CHO). In this case, the WTRU may be configured with CHO candidates at the time when recovery is triggered, and may be configured to use a CHO candidate at the recovery. If both of these apply, the WTRU may trigger cell selection at failure, and if a CHO candidate is selected, the WTRU may initiate a CHO procedure (i.e. the WTRU applies the CHO configuration and sends an RRCReconfigurationComplete message to that selected candidate rather than a reestablishment).

In LTM, the WTRU is configured with a set of candidate cells to which it may perform L1/L2 mobility. Since the WTRU already has the RRC configuration associated with each of the candidates, the mobility may be performed with lower overall latency and without the signaling overhead of RRC reconfiguration messages.

In legacy procedures, RLF/HO failure typically triggers re-establishment, which requires a RRC signaling exchange. If the WTRU is able to perform LTM instead, it would be beneficial since the RRC signaling exchange would be avoided. However, the time needed to trigger RLF may be quite long, and during that time, the WTRU may end up in a location, due to mobility, where the LTM candidate set is no longer useful. Furthermore, during the time required to trigger RLF, the network may not be able to update the candidate set at the WTRU, even though the WTRU is still able to make measurements of the configured candidates.

The terms “perform LTM” or “perform LTM procedures” may refer to performing any/all of the steps shown in FIG. 4. Specifically, early synchronization in the DL and/or UL to one or more of the candidate cells, performing L1 measurements and reporting on one or more of the candidate cells, and switching (i.e. performing handover) between candidate cells The term “perform LTM” may mean that the WTRU moves/switches between multiple candidate cells during the procedure.

The term “perform L3 recovery” may refer to performing a re-establishment procedure (i.e. transmission of an RRCRestablishmentRequest message) or performing CHO (i.e. applying a CHO configuration and transmitting an RRCReconfigurationComplete message) if the WTRU is configured with at least one CHO candidate. It may refer to any other recovery procedure that involves RRC signaling/procedures.

One or more candidate cell sets may be groups of more than one RRC configuration corresponding to a handover configuration for one or more candidate SpCells and optionally SCells. This may be modelled or received as one or more complete RRC Reconfiguration messages, one or more cell group configurations, or one or more cell configurations. Each of the candidate cell configurations may include a candidate configuration identifier, and each of the candidate cell groups may include a candidate cell group identifier. If the grouping is performed at RRC, the switching between different sets of candidate cells may include updating the serving cell indexes or candidate configuration indexes which are used in L1 and MAC signalling to refer to specific indexes, for example a MAC CE triggering the reconfiguration may include a candidate configuration index informing the WTRU which cell to perform the reconfiguration to.

The one or more candidate cell groups may be configured as a single list or group of candidate cell configurations at RRC. The grouping may occur at the early sync or LTM execution phase rather than the configuration phase, which means that the candidate cell set may be considered as a single group in terms of an RRC configuration list or group, while the cells selected for performing early sync, L1 measurements, and LTM execution depend on a further grouping into multiple subsets of the overall candidate cell list. In other words, the grouping itself may not be modelled at RRC using candidate configuration identifiers, but the grouping is executed as part of the early sync or the LTM execution procedure.

Throughout this disclosure, when referring to an LTM candidate configuration, this may apply to any type of preconfigured cell information. For example, a WTRU may be configured with one or more conditional reconfigurations such as conditional handover (CHO), conditional PSCell addition (CPA) or conditional PSCell change (CPC) which are valid before and/or after a cell change, or valid in certain cells. In this disclosure, LTM cell list, LTM candidate cell list, candidate LTM cell list, may be used interchangeably to mean the candidate cell set(s).

A WTRU may be configured with a reference cell in the set of LTM candidate cells. The reference cell may comprise the cell whose configuration is used as the reference configuration when applying a delta configuration for obtaining another cell configuration. For example, a WTRU may obtain the configuration of a target cell by applying the delta configuration provided for the target cell and applying the delta configuration on top of the reference cell (full) configuration. When moving to yet another target, the WTRU may still apply the delta configuration for the new target onto the reference cell configuration. The WTRU may be explicitly configured/indicated with a reference cell in the LTM candidate cell list (e.g. with a flag in the configuration or other implicit method for determining the reference cell).

An L1 measurement herein may comprise a measurement of RSRP, RSRP, or RSSI, performed by a WTRU of a cell, beam, set of cells, or set of beams. Such L1 measurement may be similar to L3 measurements reported in RRM, with differences in the filtering, reference signals measured, and/or reporting mechanisms.

Herein, measurements refers to L1 measurements for LTM. However, certain embodiments herein may apply also to RRM/L3 measurements, as well as other measurements (e.g. measurements of speed, location, height, and traffic).

A WTRU may be configured with a cell grouping among LTM candidate cells. Such cell grouping may be configured in the configuration of the LTM candidates themselves or via SIB signaling.

Cell grouping may be associated with the network architecture. For example, cells in the same cell group may belong to the same network node, such as to a DU or a CU. Cell grouping may be tied to WTRU behavior upon performing LTM from one cell to another cell which is within the same group or part of a different group. For example, a WTRU may perform a MAC reset when performing LTM from one cell to another cell only when the cells belong to different groups. For example, a WTRU may perform RLC re-establishment when performing LTM from one cell to another cell only when the cells belong to different groups. For example, a WTRU may perform PDCP re-establishment when performing LTM from one cell to another cell only when the cells belong to different groups.

Recovery herein refers to initiation of any of the procedures associated with recovery in legacy procedures (e.g. re-establishment). In addition, recovery may comprise of an action defined herein such as LTM to a candidate cell in the LTM set, possibly performed autonomously without any network signaling, possibly performed in addition to transmitting additional information to the network during LTM. Recovery action may comprise of legacy recovery actions (e.g. re-establishment, CHO). Recovery action may comprise of transmitting a message (e.g. a MAC CE or an RRC message), possibly in combination with or during another recovery action (e.g. LTM or CHO).

Recovery may be triggered by any of the following legacy events, such as: RLF; reconfiguration failure; handover failure; integrity check failure; or LTM failure. LTM failure may comprise of any of the following events following reception of an L1/L2 mobility command received by the network: RACH procedure failure (e.g. the WTRU is unable to receive a RACH response to a RACH preamble transmission); beam failure; lack of reception of network transmission for a period of time following LTM (e.g. no DCI); or L1 measurements below a configured threshold, possibly for a period of time, or a number of reported measurements.

Recovery may be triggered by any or a combination of the following events: a number of consecutive out of sync indications is received by L3 from the PHY layer; the start of a timer, expiration of a timer, or a timer reaching a configured threshold (e.g. T310 is started, T310 reaches a configured threshold, T310 is expired, T311 is started); a reported measurement (e.g. L1/L2 measurement or RSRP measurement) is below a configured threshold; a consecutive number of reported measurements (e.g. L1/L2 measurement or RSRP measurement) is below a configured threshold; beam failure is detected; a beam failure recovery timer reaches a threshold or expires; or the WTRU speed is above a configured threshold.

The specific recovery action (i.e. which recovery action to perform) may depend on the recovery trigger. For example, the WTRU may perform a first recovery action or set of actions upon occurrence of a first trigger and a second recovery action or set of actions upon a second trigger.

In embodiments described herein, conditions for which a first recovery action or set of actions is performed rather than a second action or set of actions, are discussed based on conditions associated with the quality of an LTM candidate set already configured at the WTRU. Such conditions may further define the specific WTRU behavior (e.g. release of a configuration or suspending a configuration) that is performed during one or more recovery actions.

The conditions for evaluation of the quality of an existing LTM candidate set may be performed based on any measurement quality (e.g. RSRP or SINR), associated with one or more of the cells in the LTM candidate set, possibly in comparison to or with reference to the serving cell, another LTM candidate cell, or a cell outside the LTM candidate set.

For example, a WTRU may evaluate a condition for determining the quality of an existing LTM candidate set as one or any combination of the following conditions: all of the cells in the candidate set have a measured quality above/below a configured threshold; all of the cells in the candidate set apart from the current serving cell have a measured quality above/below a configured threshold; the number of cells in the candidate set having a measured quality above/below a configured threshold is above/below a threshold number of cells; the ratio of the cells in the candidate set having a measured quality above/below a configured threshold is above/below a threshold ratio; or the number/ratio of LTM candidate cells whose quality is at most/at least a threshold quality different than a specific cell (e.g. the serving cell, the reference cell, etc.) is above/below a threshold number/ratio.

A WTRU may perform, as a recovery procedure described herein, autonomously triggered LTM. For example, the WTRU may perform a L1/L2 mobility like procedure autonomously without the reception of signaling from the network and upon a trigger. Such recovery procedure may comprise of any or a combination of the following actions: transmitting a RACH to the selected LTM cell; performing UL PUCCH transmission to the LTM cell; transmitting a MAC CE to the LTM cell, such as an LTM cell switch confirmation MAC CE; transmitting L1/L2 measurements to the LTM cell, such as in a MAC CE or by sending L1 measurements; or initiating L1/L2 measurements associated with reference signals and/or TCI states of the selected LTM cell.

Following UL transmission by the WTRU of autonomous LTM, the WTRU may receive a confirmation message or event which may confirm a correct operation of autonomous LTM operation. For example, the WTRU may receive a confirmation MAC CE. For example, the WTRU may receive a scheduling DCI. For example, the WTRU may receive HARQ feedback to an UL transmission. For example, the WTRU may receive a RACH response. Any of these may be an indication of a successful autonomous LTM recovery procedure. A WTRU may receive an indication of a failed recovery procedure (e.g. in a MAC CE). Alternatively, the WTRU may assume a failed autonomous LTM to a specific cell if a confirmation has not been received by a specific time.

Autonomous LTM recovery may comprise of multiple successive LTM procedures attempted to one or more of the LTM candidates in the candidate list. For example, the WTRU may successively attempt an LTM procedure to different LTM candidates as part of the recovery until a successful LTM is achieved.

A WTRU may prioritize cell selection to an LTM cell. A WTRU may select one of the configured LTM candidate cells on which to perform recovery. A WTRU may determine the type of recovery procedure to perform to a selected cell. A WTRU may perform autonomous LTM recovery prior to triggering RLF. A WTRU may perform both autonomous LTM recovery and L3 recovery in parallel. There may be conditions for selecting a LTM cell and/or determining the type of recovery. A WTRU may determine whether to maintain/release the LTM candidate cell list at recovery. A WTRU may determine whether to suspend L1/L2 measurements on LTM candidate cells. A WTRU may signal whether it maintains/releases the LTM candidate cell list at recovery. There may be conditions for determining whether/which LTM candidates are maintained at recovery. A WTRU may perform L3 recovery following LTM Recovery.

A WTRU may perform a recovery procedure to one of the configured LTM candidate cells. For example, a WTRU may be configured with an LTM candidate set. The WTRU may trigger a failure on the serving cell and may initiate a recovery procedure. Such procedure may be performed to a cell within the configured LTM candidate set, for example. In some examples, the WTRU may select and/or perform recovery to an LTM candidate cell even though non-candidate cells may be better (e.g. in terms of Uu quality) at the time of recovery. A main motivation is to save the overhead of L3 recovery compared to a simpler L1/L2 mobility procedure initiated by a WTRU. The serving cell may be the cell on which the failure which triggers recovery occurs.

A WTRU may determine whether to perform LTM or L3 recovery upon RLF based on the number of suitable LTM candidates at the time of RLF and/or the distributed unit (DU) relationship with the current cell.

A WTRU may be configured to perform L1/L2 mobility on a set of LTM candidate cells. The WTRU may be configured with or receive information regarding a threshold number of cells. The WTRU may be configured with or receive information regarding a threshold cell quality (e.g. RSRP). The WTRU may be configured with a list of cells representing the cells served by the same DU as the current cell. Upon a RLF or HO failure on the current cell or upon triggering a RLF or HO failure on the current cell, if the number of candidate LTM cells measured above the threshold cell quality is above the threshold number of cells and at least one of the LTM candidate cells which is above the threshold cell quality is served by the same DU as the current cell, the WTRU may be configured to select one of the LTM candidate cells above the threshold cell quality that is served by the same DU and may be configured to perform LTM (e.g. transmit a RACH) to the selected LTM candidate cell. Otherwise the WTRU may be configured to select a cell that is not an LTM candidate cell, release the LTM configuration, and perform CHO (i.e. transmit a RRCReconfiguration complete message) or re-establishment (i.e. transmit a RRCReestblishmentRequest message to the selected cell).

In an embodiment, a WTRU that triggers recovery may perform/prioritize cell selection to a cell that is an LTM candidate at the time of the recovery over another cell. For example, upon triggering recovery, the WTRU may perform cell selection. The WTRU may select an LTM cell rather than another cell on which to perform recovery to. Furthermore, following selection of the LTM cell, the WTRU may perform autonomous LTM as a recovery procedure. Following cell selection, the WTRU may initiate a recovery procedure.

In an embodiment, a WTRU may select one of its configured LTM candidate cells for performing recovery. A configured LTM candidate cell may comprise a configuration of other cells, including measurements, reference signals, and channels used to measure those cells, an RRC configuration to use or apply at the WTRU when the WTRU is triggered to handover to those cells. The UE may receive the LTM candidate cell configurations via an RRC message from a source cell. It may also receive the LTM candidate cell configurations in a SIB associated with the source cell. The WTRU may perform the selection, from the configured set, based on particular conditions. For example, the conditions the WTRU uses to select the cell from the configured LTM candidate cells may be any one or more of the conditions discussed below.

A WTRU may, possibly following cell selection, determine the type of recovery procedure to perform to a cell. For example, such a recovery procedure may comprise performing a L3 recovery procedure (e.g. reestablishment or CHO) or may comprise performing an autonomous LTM procedure. Similar conditions discussed below to prioritizing an LTM candidate cell over another cell may be applied for determining whether to perform L3 recovery or autonomous LTM.

In an embodiment, a WTRU may perform autonomous LTM recovery prior to triggering RLF. For example, a WTRU may be configured with conditions associated with any of the following that may cause initiation of autonomous LTM recovery.

A condition associated with a number of consecutive out of synch (OOS) indications may trigger or cause initiation of autonomous LTM recovery. For example, the WTRU may be configured with or receive information regarding a number of consecutive OOS (which may likely be smaller than the trigger of T310) which may initiate or trigger autonomous LTM recovery. For example, if the WTRU detects a number of consecutive OOS indications, the WTRU may initiate or trigger autonomous LTM recovery.

A condition associated with a status of an RLF timer (e.g. T310, T311, T312) may trigger or cause initiation of autonomous LTM recovery. For example, the WTRU may trigger or initiate autonomous LTM recovery when timer T310 is started. For example, the WTRU may trigger or initiate autonomous LTM recovery when timer T310 reaches a threshold or expires. For example, the WTRU may trigger or initiate autonomous LTM recovery when timer T311 has reached a threshold or expires.

A condition associated with a beam failure may trigger or cause initiation of autonomous LTM recovery. For example, the WTRU may be configured to initiate or trigger autonomous LTM recovery following beam failure detection on the serving cell

The above described triggers or conditions for autonomous LTM recovery may further depend on other conditions as discussed below. For example, if at the time that timer T310 is started, or during timer T310 running, if there is an LTM candidate cell for which RSRP is above a threshold, the WTRU may trigger or initiate autonomous LTM recovery to that LTM candidate cell.

In an embodiment, a WTRU may perform both autonomous LTM recovery and L3 recovery procedures in parallel. For example, this may comprise of: running timer T311 and performing cell selection in parallel with autonomous LTM recovery; running timer T311 and transmitting a RRCReestablishmentRequest message in parallel with autonomous LTM recovery; or running timer T310 in parallel with autonomous LTM recovery.

A WTRU may cancel one type of recovery when another type of recovery is successful. For example, if the WTRU receives a confirmation from the network of successful LTM recovery the WTRU may cancel L3 recovery by ignoring any RRCReestablishment message and stopping any associated L3 recovery timer. For example, if the WTRU receives an RRCReestablishment message, the WTRU may cancel ongoing autonomous LTM recovery, ignore any LTM success confirmation from the network, and stop the attempts of autonomous LTM to any candidate cell.

A WTRU may determine whether to select an LTM cell, the specific LTM cell to select, and/or whether to perform LTM recovery upon failure (e.g. RLF or HO failure) based on one or a combination of the following conditions.

A WTRU may determine whether to select an LTM cell, the specific LTM cell to select, and/or whether to perform LTM recovery upon failure based on whether the selected cell is an LTM candidate or not. For example, the WTRU may perform cell selection based on legacy criteria (e.g. select the best cell). If the selected cell is an LTM candidate, the WTRU may perform autonomous LTM recovery. In an example, a WTRU may perform cell selection and may select an LTM candidate cell. A WTRU may further use another condition as described herein (e.g. DU grouping) to determine whether to perform L3 recovery or autonomous LTM recovery.

A WTRU may determine whether to select an LTM cell, the specific LTM cell to select, and/or whether to perform LTM recovery upon failure based on a quality of the configured LTM candidate set. For example, a WTRU may perform cell selection to an LTM candidate cell if a condition on the quality of the configured LTM candidate set is met. For example, a WTRU may perform autonomous LTM recovery following cell selection to an LTM candidate cell, as opposed to performing L3 recovery, if a condition on the quality of the configured LTM candidate set is met.

A WTRU may determine whether to select an LTM cell, the specific LTM cell to select, and/or whether to perform LTM recovery upon failure based on a quality of a specific cell (e.g. the selected cell or the serving cell). For example, a WTRU may select a specific LTM candidate cell from the set of configured candidates which has the best RSRP, or any cell which has RSRP above a configured threshold.

A WTRU may determine whether to select an LTM cell, the specific LTM cell to select, and/or whether to perform LTM recovery upon failure based on a cell grouping of the LTM candidate cells. For example, a WTRU may select a cell from the LTM candidate cell list that is in the same cell group as the serving cell, and possibly has a certain cell quality. For example, a WTRU may determine whether to select an LTM cell based on whether it can find at least one LTM candidate cell, possibly that satisfies some quality conditions, that is in the same cell group as the serving cell. For example, a WTRU which selects a cell from the LTM candidate cell list may determine to perform autonomous LTM recovery if the selected cell is in the same cell group as the serving cell on which the failure occurred.

A WTRU may determine whether to select an LTM cell, the specific LTM cell to select, and/or whether to perform LTM recovery upon failure based on WTRU speed. For example, a WTRU may prioritize/select a cell from the LTM candidates if the cell has a quality which is above a threshold and the WTRU speed (e.g. at the time of recovery) is above a threshold.

A WTRU may determine whether to select an LTM cell, the specific LTM cell to select, and/or whether to perform LTM recovery upon failure based on a WTRU location/height or a change in WTRU location/height. For example, a WTRU may prioritize/select a cell from the LTM candidates if at least one cell from the LTM candidates has a quality which is above a threshold, and the WTRU has moved by less than a threshold amount from the time in which: the WTRU was last able to receive data from the serving cell; the serving cell measurement was above a threshold; the WTRU triggered the failure; and/or the WTRU initiated the recovery procedure.

A WTRU may determine whether to select an LTM cell, the specific LTM cell to select, and/or whether to perform LTM recovery upon failure based on the recovery trigger. For example, a WTRU may perform autonomous LTM recovery when the failure that triggers recovery is an LTM mobility operation, and may perform L3 recovery upon HO failure. For example, a WTRU may perform autonomous LTM recovery upon beam failure and may perform L3 mobility upon RLF. For example, a WTRU may perform autonomous LTM recovery upon starting timer T310. The WTRU may continue to monitor in synch (IS)/out of synch (OOS) indications on the target cell of the LTM recovery. If timer T310 expires without recovery on the target cell of the LTM recovery, the WTRU may trigger RLF.

A WTRU may determine whether to select an LTM cell, the specific LTM cell to select, and/or whether to perform LTM recovery upon failure based on the reference cell or a configured cell. For example, a WTRU may perform autonomous LTM to the reference cell upon failure, possibly if another condition is met. For example, a WTRU may be configured with a fallback target cell for each serving cell and may perform LTM recovery to that fallback target cell upon failure, possibly if another condition is met.

A WTRU may determine whether to select an LTM cell, the specific LTM cell to select, and/or whether to perform LTM recovery upon failure based on a network indication. For example, a WTRU may receive an indication from the network of whether to perform autonomous LTM recovery or L3 recovery. Such indication may be received during access to the target cell. For example, the WTRU may perform a RACH procedure and receive the indication of whether to perform LTM recovery or L3 recovery in the RACH response. Such indication may be received in a SIB. For example, the WTRU may receive a flag in a SIB from the target cell indicating whether to perform LTM recovery or L3 recovery to the target cell once the WTRU selects the cell following failure.

A WTRU may determine whether to select an LTM cell, the specific LTM cell to select, and/or whether to perform LTM recovery upon failure based on a conditional LTM cell switch. In an embodiment, the WTRU may receive an indication (e.g. in a MAC CE) of one cell or a set of cells to which the WTRU may perform LTM (i.e. switch to) under certain conditions. The conditions may include any one or more of those described herein (e.g. the status of an RLF timer). If one or more of the conditions are met, the WTRU may initiate cell switch to one of the cells indicated in the MAC CE. If there are more than one cell indicated, the WTRU may choose one of them randomly or select one of them based on a specific criterion (e.g. the cell with the best RSRP based on the latest CSI report). For example, the cells indicated in the MAC CE may or may not be the LTM cells configured at the WTRU.

A WTRU may determine whether to select an LTM cell, the specific LTM cell to select, and/or whether to perform LTM recovery upon failure based on a timing alignment condition. In an embodiment, the WTRU may perform LTM switch to the last cell it had been ordered to send a PRACH (e.g. with a PDCCH order). The WTRU may perform the switch under the condition that the time difference between the current time and the time when PRACH was transmitted, or the time when a RAR was received, is below a threshold In an embodiment, a WTRU may trigger recovery upon failure (e.g. RLF, HO failure, or LTM failure) while configured with an LTM candidate cell list. The WTRU may perform cell selection while prioritizing cells in the LTM candidate cell list. For example, the WTRU may select an LTM candidate cell if there is at least one LTM candidate in the LTM candidate cell list for which the cell quality is above a configured threshold. If no such cell exists, the WTRU may select a cell which is not in the LTM candidate cell list. If an LTM cell was selected, the WTRU may perform autonomous LTM to that cell. Otherwise, the WTRU may perform L3 recovery to the selected cell.

In an embodiment, a WTRU may trigger recovery upon failure (e.g. RLF, HO failure, or LTM failure) while configured with an LTM candidate cell list. The WTRU may perform cell selection while prioritizing cells in the LTM candidate cell list. For example, the WTRU may select the best suitable cell (e.g. based on a legacy definition of suitability) that is in the candidate LTM list. A legacy definition of suitability may comprise of the measured RSRP of the cell being above a configured threshold, as well as the cell belonging to the list of allowed PLMNs for the WTRU. Alternatively, the WTRU may select any suitable cell in the LTM list. If no suitable cell is in the candidate LTM list at the time of recovery, the WTRU may select another suitable cell. Upon selection of a cell in the LTM list, the WTRU may decide whether to perform autonomous LTM recovery or L3 recovery based on the cell grouping. For example, if the target cell of the recovery is in the same group as the serving cell where the failure occurred, the WTRU may initiate autonomous LTM recovery, otherwise, it may initiate L3 recovery.

In an embodiment, a WTRU may trigger recovery upon failure (e.g. RLF, HO failure, or LTM failure) while configured with an LTM candidate cell list. The WTRU may perform cell selection without cell prioritization. For example, the WTRU may select a suitable cell with the best measured cell quality. The WTRU may determine whether to perform autonomous LTM recovery or L3 recovery based on the selected cell. For example, if the selected cell is a cell in the configured LTM list, the WTRU may perform autonomous LTM recovery, otherwise, the WTRU may perform L3 recovery. If the selected cell is a cell in the configured LTM list and in the same grouping as the serving cell, the WTRU may perform autonomous LTM recovery, otherwise, the WTRU may perform L3 recovery.

In an embodiment, a WTRU may trigger recovery upon failure (e.g. RLF, HO failure, or LTM failure) while configured with an LTM candidate cell list. The WTRU may perform LTM recovery to one of the cells in the LTM candidate cell list (e.g. the cell with the best quality) which may be predetermined (e.g. the reference cell, possibly if that cell is suitable). If autonomous LTM recovery fails, the WTRU may perform L3 recovery.

In an embodiment, a WTRU may trigger recovery upon failure (e.g. RLF, HO failure, or LTM failure) while configured with an LTM candidate cell list. The WTRU may determine whether to select an LTM candidate cell or a cell which is not in the LTM candidate list based on a quality metric associated with the LTM candidate list itself. For example, if the number of cells in the LTM candidate cell list having a measurement above a quality threshold is above a threshold number of cells and at least one of these cells is in the same group as the serving cell, the WTRU may select one of these cells (e.g. the best cell) and perform LTM recovery. Otherwise, the WTRU may select a cell which is not on the LTM cell list and perform L3 recovery. For example, if the number of cells in the LTM candidate cell list which are part of the same group as the serving cell is above a threshold number of cells and at least one of these cells is in the same group as the serving cell, the WTRU may select one of these cells (e.g. the best cell) and perform LTM recovery. Otherwise, the WTRU may select a cell which is not on the LTM cell list and perform L3 recovery.

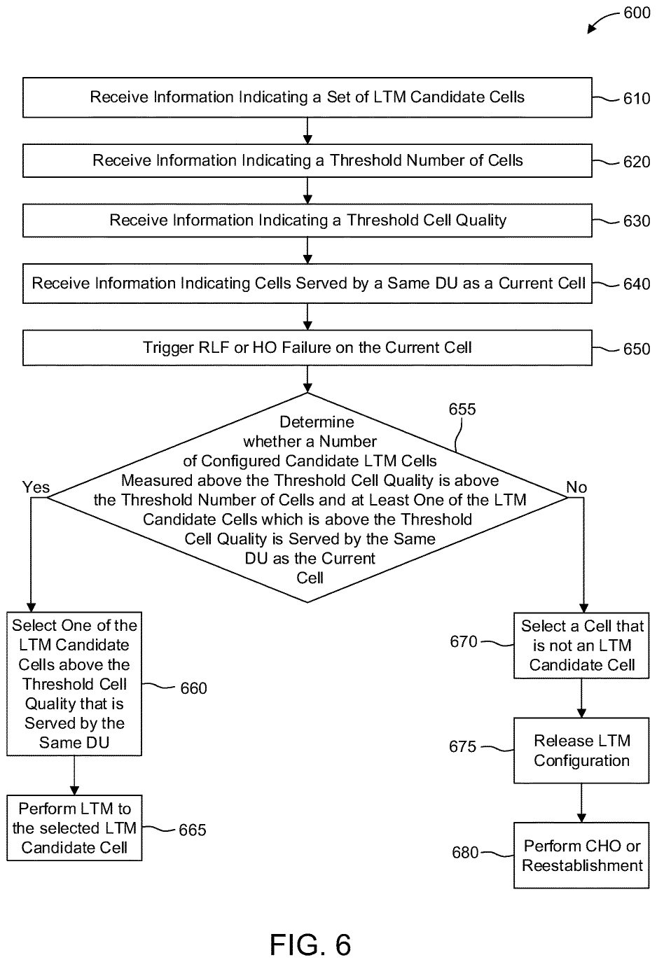

FIG. 6 shows an example method 600 of LTM recovery based on a number of suitable LTM candidates at the time of RLF and/or a DU relationship with a current cell. A WTRU may receive or be configured with information indicating a set of LTM candidate cells 610. The WTRU may receive or be configured with information indicating a threshold number of cells 620. The WTRU may receive or be configured with information indicating a threshold cell quality value 630. The threshold cell quality value may be, for example, an RSRP value. The WTRU may receive information indicating cells served by a same DU as a current cell 640. The information may be a list of cells representing or indicating cells service by a same DU as a current cell. The WTRU may receive the above information (e.g. information indicating a set of LTM candidate cells, information indicating a threshold number of cells, information indicating a threshold cell quality, and information indicating a cells served by a same DU as a current cell) in a same message or one or more different messages. The WTRU may determine that RLF or HO failure occurs on the current cell or may trigger RLF or HO failure on the current cell 650. The WTRU may measure the candidate LTM cells against the threshold cell quality value. The WTRU may determine whether a number of candidate LTM cells measured above the threshold cell quality value is above the threshold number of cells and at least one of the LTM candidate cells which is above the threshold cell quality value is served by the same DU as the current cell 655. If both of these conditions is true, the WTRU may select one of the LTM candidate cells above the threshold cell quality value that is served by the same DU 660 and perform LTM to the selected LTM candidate cell 665. If either of those conditions are false, the WTRU may select a cell that is not an LTM candidate cell 670, release the LTM configuration 675, and perform CHO or reestablishment 680. An LTM configuration may comprise the RRC parameters to be used by the WTRU when cell switch is triggered to that cell, as well as measurements, reference signals, and TCI states, associated with monitoring or measuring the cell prior to cell switch.

A WTRU may determine whether to release the LTM configuration and inform the network following a RLF based on the number of suitable LTM candidates at the time of RLF, the WTRU speed, and/or DU relationship of the remaining candidates.

A WTRU may be configured to perform L1/L2 mobility on a set of LTM candidates. The WTRU may be configured with or receive information regarding a threshold cell quality (e.g. RSRP). The WTRU may be configured with or receive information regarding a threshold number of cells. The WTRU may be configured with or receive information regarding a threshold WTRU speed. The WTRU may be configured with or receive information regarding a list of cells representing the cells served by the same DU as the current cell. Upon detecting RLF or HO failure on the current cell, the WTRU may perform cell selection. If the selected cell is an LTM candidate, the WTRU may perform LTM to the selected cell such that if any or a combination of the following is satisfied: if the number of configured LTM candidate cells measured above the threshold cell quality is above the threshold number of cells; if the WTRU speed is below a threshold; or if the LTM candidate cells measured above a threshold cell quality all belong to the same DU as the selected candidate, the WTRU may maintain the LTM configuration and measurement configuration/reporting and inform the network of the maintenance (e.g. using a MAC CE). Otherwise the WTRU may inform the network of the deactivation/release (e.g. using an RRC message) and perform either of the following: deactivate the LTM measurements or measurement reporting configuration, or release the LTM measurements or measurement reporting configuration. Otherwise, if the selected cell is not an LTM candidate, the WTRU may release the LTM configuration and perform CHO (i.e. transmit an RRCReconfiguration complete message) or re-establishment (i.e. transmit an RRCReestblishmentRequest message to the selected cell).

In an embodiment, a WTRU may maintain the LTM candidate cell list at recovery. Such may be the case for an LTM recovery procedure, a L3 recovery procedure, or both. A WTRU may be configured with conditions for determining whether to maintain or release the LTM candidate cell list at recovery. A WTRU may indicate to the network, during the recovery procedure, whether it will maintain or release the LTM candidate cell list.

A WTRU may maintain a subset of the LTM candidates in the LTM candidate cell list. In such a case, the WTRU may indicate (e.g. using a set of indices) which of the candidates are maintained. Alternatively, the WTRU may indicate implicitly (e.g. by sending L1 measurements of the LTM candidates in the cell list) which of the candidates were maintained.

In an embodiment, a WTRU that performs recovery where it maintains the LTM candidate cell list at recovery, may suspend L1/L2 measurements on LTM candidate cells following recovery. For example, based on a condition being met, the WTRU may suspend LTM measurements after recovery, while based on the condition not being met, the WTRU may perform LTM measurements (e.g. perform measurements and reporting to the network) after recovery. Conditions for suspending measurements may be the same/similar as conditions for maintaining/releasing the cell list at recovery.

In an embodiment, a WTRU may signal or send an indication of whether it maintains or releases the LTM cell list to the network. The WTRU may send such indication during the recovery procedure. For example, the WTRU may send a flag in any UL message which is part of the recovery procedure. The WTRU may send a message (e.g. a MAC CE or RRC message) after recovery to indicate whether the LTM candidate cell list has been maintained.

The type of message/signaling used by the network may depend on whether the WTRU has maintained or released the LTM candidate cell list. For example, the WTRU may transmit L1/L2 measurements if the WTRI has maintained the LTM candidate cell list. For example, the WTRU may indicate, for example, using a flag in an UL MAC CE which may be transmitted during the LTM recovery procedure, that the list of cells has been released. For example, the WTRU may transmit an UL RRC message indicating the specific cells the WTRU has maintained. The UL RRC message may be sent following the recovery procedure.

A WTRU may be configured with one or a combination of the following conditions for determining whether to maintain or release the LTM candidate cell list at recovery. In addition, a WTRU may be configured with one or a combination of the following conditions for determining which of the LTM candidate cells to maintain at recovery.

The conditions may include the type of recovery. For example, if the WTRU attempts/succeeds LTM recovery, it may maintain the LTM candidate cell list. If the WTRU attempts/succeeds an L3 recovery, the WTRU may release the LTM candidate cell list.

The conditions may include the quality of the configured LTM candidate cell set. For example, if any condition associated with the quality of the configured LTM candidate cell set is met, the WTRU may maintain the LTM candidate cell set, otherwise, the WTRU may release the LTM candidate cell set.

The conditions may include the quality of a specific cell, either a LTM candidate cell or other cell which is not an LTM candidate cell. For example, a WTRU may maintain any/all LTM candidate cells whose cell quality is above a threshold value at recovery. For example, if the quality of a cell which is not in the LTM candidate cell list at the time of recovery is above a threshold, the WTRU may release the LTM candidate cell list.

The conditions may include a cell grouping of the LTM candidate cells, the target cell, and/or the serving cell. For example, a WTRU may maintain the LTM candidate cell list if the WTRU performs LTM recovery to a cell which is in the same cell grouping as the serving cell, and may release the LTM candidate cell list otherwise. For example, the WTRU may maintain only the LTM candidate cells which are in the same group as the target cell of the recovery or as the serving cell.

The conditions may include a WTRU speed. For example, a WTRU may maintain the LTM candidate cell list if the WTRU speed at the time of recovery is below a threshold value. For example, a WTRU may be configured with a threshold WTRU speed for each LTM candidate in the LTM candidate cell list and may maintain only the candidates in the LTM candidate cell list where the WTRU's speed is below the corresponding configured threshold value.

The conditions may include WTRU location/height or a change in WTRU location/height. For example, a WTRU may maintain the LTM candidate cell list if the WTRU location or height changes by less than a configured threshold value during the recovery procedure, or from some time instant prior to recovery.

The conditions may include the recovery trigger. For example, a WTRU may maintain the LTM candidate cell list when recovery is triggered by LTM mobility failure, and may release the LTM candidate cell list when recovery is triggered by RLF.

The conditions may include a network indication. For example, a WTRU may receive an indication from the network (e.g., during the recovery procedure) of whether to maintain or release the LTM candidate cell list. For example, the WTRU may receive, in the confirmation MAC CE, an indication of whether to maintain or release the LTM candidate cell list. For example, the WTRU may receive in the RACH response an indication of whether to maintain or release the LTM candidate cell list. For example, a WTRU may receive, in a network message (e.g. a MAC CE), a subset of the LTM candidate cells which the WTRU should release.

In an embodiment, a WTRU may trigger recovery and select a cell which is an LTM candidate cell. Upon selection of an LTM candidate cell, the WTRU may trigger an autonomous LMT recovery procedure. The WTRU, upon triggering of the recovery procedure, may determine whether to maintain or release the LTM candidate cell list. For example, if the number of LTM candidates in the LTM candidate cell list whose quality is above a threshold value is larger than a threshold number, the WTRU may maintain the LTM candidate cell list. Otherwise, the WTRU may release the LTM candidate cell list. For example, if the WTRU speed is below a threshold value, the WTRU may maintain the LTM candidate cell list. Otherwise, the WTRU may release the LTM candidate cell list. For example, if all of the LTM candidates measured above a threshold value are in the same group as the target cell, the WTRU may maintain the LTM candidate cell list. For example, if at least one of the LTM candidates measured above a threshold value is in the same group as the target cell, the WTRU may maintain the LTM candidate cell list.

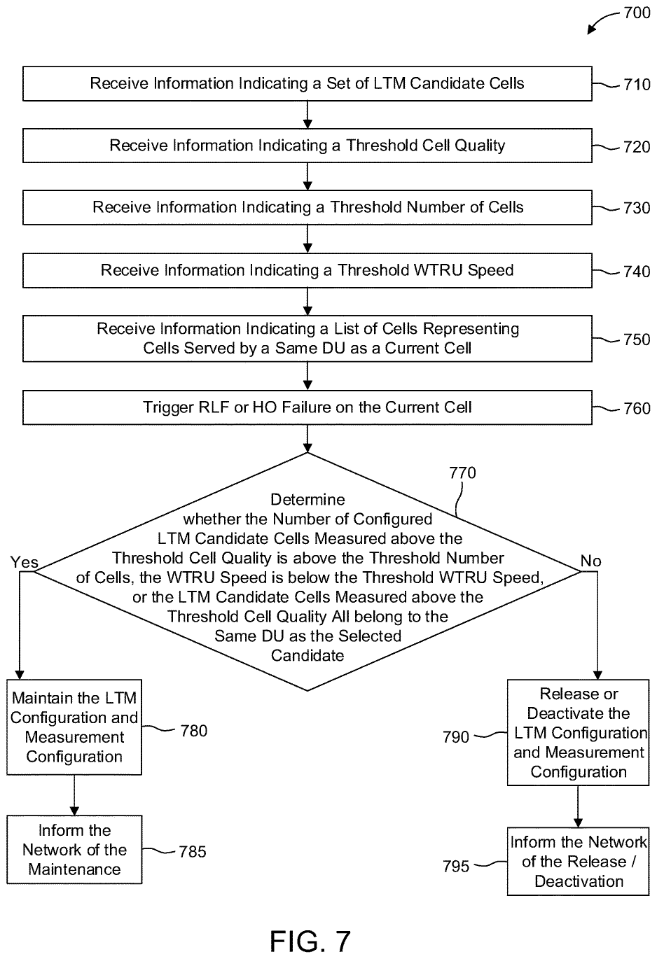

FIG. 7 shows an example method 700 for releasing or maintaining an LTM configuration following an RLF based on a number of suitable LTM candidates at the time of RLF, a WTRU speed, and/or a DU relationship of the remaining candidates. A WTRU may receive or be configured with information indicating a set of LTM candidate cells 710. The WTRU may receive or be configured with information indicating a threshold cell quality 720. The WTRU may receive or be configured with information indicating a threshold number of cells 730. The WTRU may receive or be configured with information regarding a threshold WTRU speed 740. The WTRU may receive or be configured with information indicating a list of cells representing cells served by a same DU as a current cell 750. The WTRU may receive the above information (e.g. information indicating a set of LTM candidate cells, information indicating a threshold cell quality, information indicating a threshold number of cells, information indicating a threshold WTRU speed, and information indicating a list of cells representing cells served by a same DU as a current cell) in a same message or one or more different messages. The WTRU may determine that RLF or HO failure occurs on the current cell or may trigger RLF or HO on the current cell 760. The WTRU may determine whether the number of configured LTM candidate cells measured above the threshold cell quality is above the threshold number of cells, the WTRU speed is below the threshold WTRU speed, or the LTM candidate cells measured above the threshold cell quality all belong to the same DU as the selected candidate (770). If at least one of the conditions is true, the WTRU may maintain the LMT configuration and measurement configuration (780) and inform the network as to the maintenance (785). If none of the conditions is true, the WTRU may release or deactivate the LTM configuration and measurement configuration (790) and inform the network of the release/deactivation (795).

A WTRU may determine whether to perform LTM and subsequent L3 recovery based upon detecting RLF based on the presence of an acceptable LTM cell and presence/amount/type of ongoing data transmission in the uplink (UL).

A WTRU may be configured to perform L1/L2 mobility on a set of LTM candidates. The WTRU may be configured with or receive information regarding a first RSRP cell quality threshold value (i.e. suitable cell). The WTRU may be configured with or receive information regarding a second RSRP cell quality threshold value (i.e. acceptable cell). The second RSRP cell quality threshold value may be less than the first RSRP cell quality threshold value. The WTRU may be configured with or receive information regarding a threshold priority value. The WTRU may be configured with or receive information regarding a threshold data amount value. The WTRU may be configured with or receive information regarding a threshold period of time for transmission to an acceptable cell. Upon determining or triggering RLF or HO failure on the current cell, if no suitable LTM cells is found and if at least one acceptable LTM cell is found and the WTRU has pending UL data that satisfies one of the following conditions: (i) the data in the UL buffers is above the threshold priority value or (ii) the amount of data in the UL buffers is above the threshold data amount value, the WTRU may perform LTM recovery to the acceptable LTM cell. The WTRU may perform CHO or reestablishment if the current serving cell remains below the first RSRP cell quality threshold value for at least the configured threshold period of time following LTM. If at least one acceptable LTM cell is not found or the WTRU does not have pending UL data that satisfies one of the following conditions of: (i) the data in the UL buffers is above the threshold priority value or (ii) the amount of data in the UL buffers is above the threshold amount value; the WTRU may release the LTM configuration and perform CHO (i.e. transmit a RRCReconfiguration complete message) or re-establishment (i.e. transmit a RRCReestblishmentRequest message) to the selected cell. If a suitable LTM cell is found, the WTRU may perform LTM on a suitable LTM cell.

In an embodiment, a WTRU may trigger L3 recovery following LTM recovery or sometime after LTM recovery. A WTRU may be configured with one or more conditions for which to initiate L3 recovery following LTM recovery, whereby such conditions may be different than normal conditions for L3 recovery only. A WTRU may initiate L3 recovery following LTM recovery after a period of time following LTM recovery. For example, the conditions for performing L3 recovery following LTM recovery may be evaluated prior to completion of LTM recovery. Following completion of LTM recovery, the WTRU may evaluate other conditions, possibly during a period of time following LTM recovery, to determine whether to initiate subsequent L3 recovery. The WTRU may determine, after LTM recovery, whether to evaluate certain conditions for initiating L3 recovery, based on satisfying other conditions which may have been evaluated prior to or during the execution of LTM recovery.

In an example, the WTRU may evaluate some conditions, and if such conditions are met, the WTRU may perform LTM recovery with the possibility of L3 recovery following LTM recovery. If the conditions are not met, the WTRU may perform LTM recovery. If the conditions are not met, the WTRU may perform L3 recovery alone.

In an example, a WTRU may initiate LTM recovery, and may, after a configured period of time on the new target cell, initiate a reestablishment or CHO procedure.

In an example, the WTRU may perform LTM recovery in a different way (e.g. the procedure may involve different steps) when performed with the decision that it may perform a subsequent L3 recovery, possibly after a certain time period, possibly if other conditions are satisfied. For example, if the WTRU performs LTM recovery, it may wait for confirmation from the network before performing an UL transmission (e.g. in a configured grant). If the WTRU performs LTM recovery with the possibility of performing subsequent L3 recovery, it may perform an UL transmission without confirmation of the LTM recovery from the network.

A WTRU may evaluate one or a combination of conditions for determining whether it may perform L3 recovery following LTM recovery. Such conditions may be evaluated prior to or during LTM recovery execution. Such conditions may be evaluated following LTM recovery execution. A WTRU may, if certain conditions are met, evaluate another set of conditions after LTM recovery execution for determining whether to initiate L3 recovery.

A condition for determining whether a WTRU may perform L3 recovery following LTM recovery may be conditions on cell quality, possibly of the target cell, possibly of the serving cell, possibly of any other cell which may be a candidate for recovery. For example, after triggering recovery, if the WTRU is unable to find a cell with a quality above a first threshold value, the WTRU may select a cell with a quality above a second (e.g. lower) threshold value and may perform LTM recovery with the expectation of performing L3 recovery after a period of time following LTM recovery. For example, after deciding to perform LTM recovery, the WTRU may perform subsequent L3 recovery if the target cell on which LTM recovery was performed has a quality which remains below the first threshold value. If the quality of the target cell improves to being above the first threshold value, the WTRU may not perform any subsequent L3 recovery.

A condition for determining whether a WTRU may perform L3 recovery following LTM recovery may be conditions based on time, possibly corresponding to the amount of time elapsed since the attempt/completion of LTM recovery, possibly corresponding to the amount of time elapsed since the failure event that initiated LTM recovery, possibly corresponding to the amount of time since the occurrence of an event described herein that may have occurred prior to or after LTM recovery execution. For example, a WTRU may perform L3 recovery a period of time following an attempt/completion of LTM recovery when a condition is met. For example, if a condition is not met prior to a period of time following LTM recovery attempt/completion expiring, the WTRU may perform L3 recovery.

A condition for determining whether a WTRU may perform L3 recovery following LTM recovery may be conditions based on the type or QoS of data buffered at the WTRU or being transmitted to the WTRU. For example, the WTRU may perform L3 recovery following LTM recovery if the WTRU has data buffered, possibly associated with a specific QoS or associated with a specific logical channel, at the time when LTM recovery is triggered. For example, the WTRU may be configured on a per logical channel as to whether to perform LTM recovery followed by L3 recovery, or to perform L3 recovery only. For example, the WTRU may be configured with a flag per logical channel. If the WTRU has data available for transmission associated with a logical channel configured with the flag, the WTRU may perform LTM recovery and initiate monitoring of the conditions to perform subsequent L3 recovery.

A condition for determining whether a WTRU may perform L3 recovery following LTM recovery may be conditions associated with IS and/or OOS indications from, for example, the PHY layer. For example, the WTRU may initiate LTM based on certain triggers associated with the number of consecutive OOS indications, and may perform subsequent L3 recovery based on whether a number of consecutive IS indications is received following LTM recovery.

A condition for determining whether a WTRU may perform L3 recovery following LTM recovery may be conditions associated with cell grouping. For example, the behavior of LTM following L3 may depend on selecting a cell which is part of the same cell group, and which may warrant the attempt of LTM recovery. For example, the WTRU may select a lower quality cell for recovery because the lower quality cell may be part of the same cell group as the serving cell. The WTRU may then attempt LTM recovery for a period of time, and if the quality of that cell does not improve during that time, the WTRU may trigger L3 recovery to another cell which was higher in quality.

In an example, a WTRU may be configured with two thresholds for evaluation of cell quality at the time recovery is triggered. If the WTRU is able to find a cell with quality above a first (higher) threshold, the WTRU may perform L3 recovery or LTM recovery. Whether the WTRU performs L3 recovery or LTM recovery may be based on conditions described in other embodiments described herein. If the WTRU is not able to find a cell with a quality above the first threshold, but is able to find a cell with a quality above a second threshold, the WTRU may perform LTM recovery to the cell above the second threshold. The WTRU may initiate a timer following the attempt of LTM recovery. If the timer expires, or time associated with timer elapses, and the cell to which LTM was performed does not improve to above the first threshold, the WTRU may initiate L3 recovery.

In an example, a WTRU may be configured with two thresholds for evaluation of cell quality at the time recovery is triggered. If the WTRU is able to find a cell with quality above a first (higher) threshold, the WTRU may perform L3 recovery or LTM recovery. Whether the WTRU performs L3 recovery or LTM recovery may be based on conditions described in other embodiments described herein. If the WTRU is not able to find a cell with a quality above the first threshold, but is able to find a cell with a quality above a second threshold and the WTRU has data available for transmission associated with a configured logical channel (LCH), the WTRU may perform LTM recovery. The WTRU may initiate a timer following the attempt of LTM recovery and when the timer expires, or a time associated with the timer elapses, the WTRU may initiate L3 recovery.

In an example, LTM recovery followed by L3 recovery may be performed based on counting of IS/OOS indications, similar to the triggering of timer T310. For example, the WTRU may initiate LTM recovery when the number of consecutive OOS indications reaches a configured value or amount. Following this, the WTRU may initiate a timer. If the timer expires, or a time associated with the timer elapses, before the WTRU receives a number of consecutive IS indications, the WTRU may trigger L3 recovery.

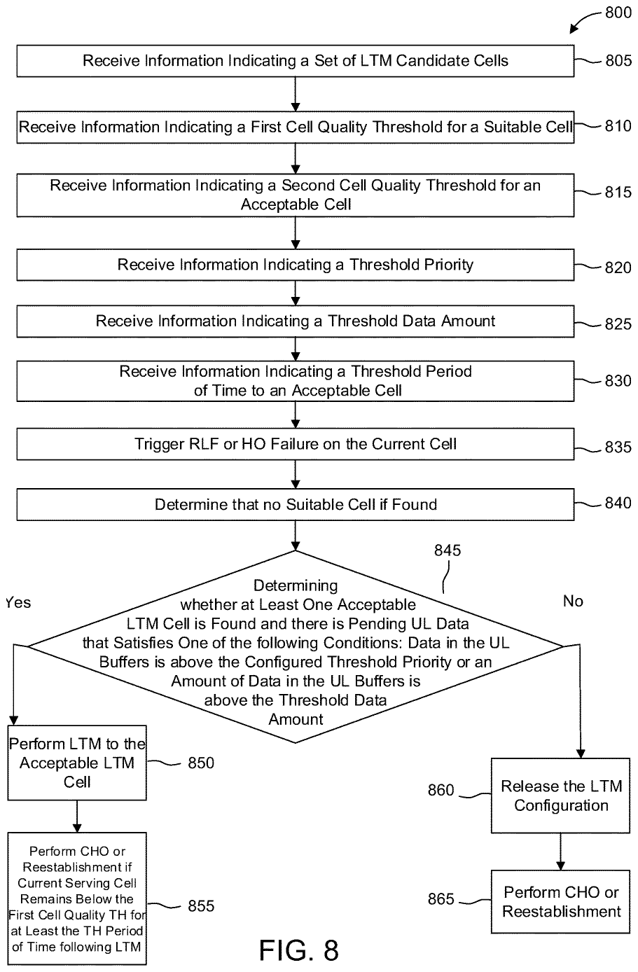

FIG. 8 shows an example method 800 of LTM recovery based on the presence of an acceptable LTM cell and a presence, amount, or type of ongoing uplink data transmission. A WTRU may receive or be configured with information indicating a set of LTM candidate cells 805. The WTRU may receive or be configured with information indicating a first cell quality threshold value for a suitable cell 810. For example, the cell quality threshold value may be an RSRP value. A suitable cell may be a cell that has a cell quality (e.g. RSRP) greater than, or greater than or equal to, the first cell quality threshold value. The WTRU may receive or be configured with information indicating a second cell quality threshold value for an acceptable cell 815. For example, the cell quality threshold value may be an RSRP value. An acceptable cell may be a cell that has a cell quality (e.g. RSRP) greater than, or greater than or equal to, the second cell quality threshold value. The second cell quality threshold value (acceptable cell) may be less than the first cell quality threshold value (suitable cell). The WTRU may receive or be configured with information indicating a threshold priority value 820. The WTRU may receive or be configured with information indicating a threshold data amount value 825. The WTRU may receive or be configured with information indicating a threshold period of time to an acceptable cell 830. The WTRU may receive the above information (e.g. information indicating a set of LTM candidate cells, information indicating a first cell quality threshold value for a suitable cell, information indicating a second cell quality threshold value for an acceptable cell, information indicating a threshold priority value, information indicating a threshold data amount value, and information indicating a threshold period of time to an acceptable cell) in a same message or one or more different messages. The WTRU may determine or trigger RLF or HO failure on the current cell 835. The WTRU may determine that no suitable cell is found 840. The WTRU may determine that there is no suitable cell based on a determination that no LTM candidate cell has a cell quality that is greater than the first cell quality threshold value. The WTRU may determine whether at least one acceptable LTM cell is found and that there is pending UL data that satisfies at least one of the following conditions: data in the UL buffer(s) is above the threshold priority value (e.g. a priority associated with data in the UL buffer(s) is above the threshold priority data or a highest priority associated with the data in the UL buffer(s) is above the threshold priority value) or an amount of data in the UL buffer(s) is above the threshold data amount 845. The WTRU may determine that at least one acceptable cell is found if at least one LTM candidate cell has a cell quality that is greater than the second cell quality threshold value. If at least one acceptable LTM cell is found and the data in the UL buffer(s) that is above the threshold priority value (e.g. a priority associated with data in the UL buffer(s) is above the threshold priority data or a highest priority associated with the data in the UL buffer(s) is above the threshold priority value) or an amount of the data in the UL buffer(s) is above the threshold data amount, the WTRU may perform LTM recovery to the acceptable LTM cell 850. After the LTM recover, if the current serving cell remains below the first RSRP threshold value for at least the threshold period of time following LTM, the WTRU may perform CHO or reestablishment 855. If at least one acceptable LTM cell is not found or the data in the UL buffer(s) that is not above the threshold priority value or an amount of the data in the UL buffer(s) is not above the threshold data amount, the WTRU may release the LTM configuration 860 and perform conditional handover (CHO) or reestablishment 865.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for L1/L2 mobility (LTM) recovery implemented by a wireless transmit/receive unit (WTRU), the method comprising:
receiving information indicating a set of LTM candidate cells;
receiving information indicating a threshold number of cells;
receiving information indicating a threshold cell quality value;
receiving information indicating cells served by a same distributed unit (DU) as a current cell;
determining that a radio link failure (RLF) or handover (HO) failure occurs on the current cell; and
based on a number of LTM candidate cells measured above the threshold cell quality value being above the threshold number of cells and at least one of the LTM candidate cells which is above the threshold cell quality value being served by the same DU as the current cell:
selecting one of the LTM candidate cells above the threshold cell quality value that is served by the same DU; and
performing LTM recovery to the selected LTM candidate cell.

2. The method of claim 1, wherein performing LTM recovery comprises transmitting a random access channel (RACH) transmission.

3. The method of claim 1, further comprising:
based on a number of LTM candidate cells measured above the threshold cell quality value not being above the threshold number of cells or at least one of the LTM candidate cells which is above the threshold cell quality value not being served by the same DU as the current cell:
selecting a cell that is not an LTM candidate cell;
releasing an LTM configuration; and
performing conditional handover (CHO) or reestablishment.

4. The method of claim 3, wherein performing CHO comprises transmitting a radio resource control (RRC) reconfiguration complete message.

5. The method of claim 3, wherein performing reestablishment comprises transmitting a radio resource control (RRC) reestablishment request message to the selected cell that is not an LTM candidate cell.

6. The method of claim 1, wherein the threshold cell quality value is a reference signal received power (RSRP) value.

7. The method of claim 1, further comprising:
measuring a cell quality of the LTM candidate cells against the threshold cell quality value.

8. The method of claim 1, further comprising:
determining whether a number of LTM candidate cells measured above the threshold cell quality value is above the threshold number of cells.

9. The method of claim 8, further comprising:
determining whether at least one of the LTM candidate cells which is above the threshold cell quality value is served by the same DU as the current cell.

10. The method of claim 1, wherein the selecting one of the LTM candidate cells is based on a cell quality, a cell grouping, a WTRU speed, a change in WTRU location, a change in WTRU height, a type of failure, a network indication, or a timing alignment.

11. A wireless transmit/receive unit (WTRU) configured to perform L1/L2 mobility (LTM) recovery, the WTRU comprising:
a receiver configured to receive information indicating a set of LTM candidate cells;
the receiver is further configured to receive information indicating a threshold number of cells;
the receiver is further configured to receive information indicating a threshold cell quality value;
the receiver is further configured to receive information indicating cells served by a same distributed unit (DU) as a current cell;
a processor configured to determine that a radio link failure (RLF) or handover (HO) failure occurs on the current cell;
on a condition that a number of LTM candidate cells measured above the threshold cell quality value is above the threshold number of cells and at least one of the LTM candidate cells which is above the threshold cell quality value is served by the same DU as the current cell:
the processor is further configured to select one of the LTM candidate cells above that threshold cell quality value that is served by the same DU; and
a transmitter and the processor are configured to perform LTM recovery to the selected LTM candidate cell.

12. The WTRU of claim 11, wherein the processor and the transmitter are further configured to transmit a random access channel (RACH) transmission for LTM recovery.

13. The WTRU of claim 11, wherein:
on a condition that a number of LTM candidate cells measured above the threshold cell quality value is not above the threshold number of cells or at least one of the LTM candidate cells which is above the threshold cell quality value is not served by the same DU as the current cell:
the processor is further configured to select a cell that is not an LTM candidate cell;
the processor is further configured to release an LTM configuration; and
the processor and the transmitter are further configured to perform conditional handover (CHO) or reestablishment.

14. The WTRU of claim 13, wherein the processor and the transmitter are further configured to transmit a radio resource control (RRC) reconfiguration complete message for CHO.

15. The WTRU of claim 13, wherein the processor and the transmitter are further configured to transmit a radio resource control (RRC) reestablishment request message to the selected cell that is not an LTM candidate cell for reestablishment.

16. The WTRU of claim 11, wherein the threshold cell quality value is a reference signal received power (RSRP) value.

17. The WTRU of claim 11, wherein the processor is further configured to measure a cell quality of the LTM candidate cells against the threshold cell quality value.

18. The WTRU of claim 11, wherein the processor is further configured to determine whether a number of LTM candidate cells measured above the threshold cell quality value is above the threshold number of cells.

19. The WTRU of claim 18, wherein the processor is further configured to determine whether at least one of the LTM candidate cells which is above the threshold cell quality value is served by the same DU as the current cell.

20. The WTRU of claim 11, wherein the selected one of the LTM candidate cells is based on a cell quality, a cell grouping, a WTRU speed, a change in WTRU location, a change in WTRU height, a type of failure, a network indication, or a timing alignment.
